(19) United States
(12) Patent Application Publication
(10) Pub. No.: US 2002/0128749 A1
(43) Pub. Date: Sep. 12, 2002

(54) Energy and power interchange system and its method

(75) Inventors: Hiroshi Arita, Mito-shi (JP); Masahiro Watanabe, Hitachi-shi (JP); Junichi Makino, Hitachinaka-shi (JP); Tadashi Senda, Tokyo (JP); Youichi Ohshita, Hitachinaka-shi (JP); Genichiro Ichihari, Tokyo (JP); Naoyuki Yamada, Hitachinaka-shi (JP); Tetsuo Horiuchi, Hitachi-shi (JP); Chihiro Fukui, Hitachinaka-shi (JP); Hiroyuki Kudo, Tokyo (JP)

Correspondence Address: MATTINGLY, STANGER & MALUR, 104 East Hume Avenue, Alexandria, VA, 22301, US

(73) Assignee: Hitachi, Ltd.

(21) Appl. No.: 09/840,071

(22) Filed: Apr. 24, 2001

Related U.S. Application Data
(63) Continuation of application No. 09/290,170, filed on Apr. 13, 1999.

(30) Foreign Application Priority Data
Apr. 15, 1998 (JP) 10-104349

(51) Int. Cl. G05D 3/12

(52) U.S. Cl. 700/286; 700/287; 705/412

(57) ABSTRACT

To realize the multinational energy and power interchange, understanding the characteristics and differences of energy and power system of respective countries, electric power facilities of respective countries must be totally operated thus providing economic effects such as lowering of energy charge and the stable power supply. To this end, the respective power systems of many countries and regions such as North America, Russia, China, South East Asia, Australia, South America and the like belonging to the Asian-Pacific rim which have characteristics and difference are connected by direct current interconnecting facilities or alternating power transmission facilities thus ensuring the balance of power supply and enabling the total or partial operation of the entire system.

### BACKGROUND OF THE INVENTION

This invention relates to an energy and power interchange system and method for interchanging power in a wide area extending over a plurality of countries, and more particularly the energy and power interchange system for interchanging and its method which take into account the time difference and the regional difference.

With respect to the power demand and supply, along with the economic development of respective regions, the absolute value of the power demand is increasing and the peak load is also increasing, while the load factor is lowering year by year. To cope with this phenomenon, electric utilities are requested to build power plants having power source capacity which can make up for this peak load. Recently, the regions which cannot respond to the rapid power demand adopt measures to supply electric power to the regional load by means of distributed power sources such as IPP (abbreviation of independent power producers) which can be developed in a short period.

To meet the request to increase the facilities of electric power system, the construction of power plants, transmission lines and substations which can transmit electric power corresponding to the increasing load. In the vicinity of urban cities, however, it is difficult to obtain a site for nuclear power and hydraulic power source is remote from the place of demand in general. On the other hand, recently, in terms of environmental problems and the like, it is getting harder and harder to secure sites which are available for power plants so that the problem that the construction of new power plants is difficult has become apparent.

As one of measures to solve this problem, for increasing the serviceability of existing power plants, the efficient system operation between countries has been considered. To this end, the technology which can increase the stability of the existing systems and strengthen the transmission ability becomes necessary and as tasks for the control and operation of the system, maintenance and administration of the fluctuation of voltage and frequency by restricting the fluctuation of the system and realization of reasonable electric power distribution through the power interchange or transmission under consignment are named. To restrict the fluctuation of the system, the control of electric generators and the control of load are available and it is necessary to strengthen the system interconnection through the alternating current or the direct current.

As a plan for multinational system interconnection, CIGRE Keynote Address (Paris, Aug. 28, 1994) has been proposed. In this literature, as an Africa—Europe system interconnection, a system inter connection around Mediterranean Sea and an interconnection on the African Continent are introduced. For example, with respect to the system interconnection on the African Continent, as effects of application, (1) interconnection of peak load between winter season and summer season and (2) reduction of daily system peak load considering 4 hours time difference between the east and the west are described. This literature, however, merely suggests the development of the Zaire located at the center of Africa and the construction of hydro electric power plant and its estimated power of 40 GW (100 GW in future) and fails to describe how the plan is realized with any concrete means.

To realize the multinational power interchange actually, it is essential to provide concrete means to interconnect own power system with the power systems of other countries corresponding to the features of power systems of respective countries and differences of power systems among respective countries. Furthermore, it is necessary to decide the operation mode corresponding to the situations of respective countries.

### SUMMARY OF THE INVENTION

It is the first object of the present invention to obtain economic effects such as reduction of electric rates by operating the power facilities of a plurality of countries in a comprehensive manner.

It is the second object of the present invention to provide a stable supply of power by operating the power facilities of a plurality of countries in a comprehensive manner.

It is the third object of the present invention to obtain social effects such as reduction of environmental load and the regional gap by operating the power facilities of a plurality of countries in a comprehensive manner.

To achieve the above objects, the energy and power interchange system of the present invention comprises a system including energy generating means which generates transmittable energy using an energy source, an energy path which transmits energy generated by the energy generating means, a measuring equipment which is mounted on the energy path for measuring an amount of energy which is transmitted through the energy path, and a system which consumes energy supplied by way of the energy path and the energy and such a power interchange system is characterized in that the energy sources used by the energy generating means and the generated energy amount are controlled in response to the energy amount measured by the measuring equipment.

Furthermore, in an energy and power interchange system which comprises a first system including power generating facilities, a second system in foreign countries having power generating facilities, an energy path constructed by a direct current transmission system which interconnects the first system and the second system, and a measuring equipment which is mounted on the energy path and measures an energy amount transmitted through the energy path, the system is characterized in that control parameters of the first and the second systems are changed or the transmitting direction of energy is decided in response to the energy amount measured by the measuring equipment.

Furthermore, in an energy and power interchange system which comprises an energy path constituted by a direct current transmission system which interconnects systems of at least three foreign countries having power generating facilities and a measuring equipment which is mounted on the energy path and measures the energy amount transmitted through the energy path, the system is characterized in that the control parameters of the systems of at least three countries are changed or the transmitting direction of energy is decided in response to the energy amount measured by the measuring equipment.

Furthermore, the energy and power interchange system includes an interconnection adjustment equipment which transmits converted values to respective systems in response to information measured by the measuring equipment, wherein the converted values are converted values of expenses including energy generating expense and energy transmission expense or converted values of environmental load including generated carbon oxide gas. Furthermore, the energy and power interchange system includes an interchange administration equipment which carries out the settlement, the conclusion of contract or the interchange control using the converted values transmitted from the interconnection adjustment equipment. Furthermore, a power storage equipment is installed in at least one of the systems and the input and output of the power storage equipment is controlled in response to the change of power flow rate between systems. Furthermore, respective systems are located at countries which differ in circulating currency and they convert to the preliminarily decided currency unit or carry out such a conversion based on the information on the exchange rate or the above-mentioned respective systems are located in countries which differ in languages and information is transmitted by way of translating machines. Furthermore, the system comprises a system which includes many thermal power facilities and a system which include many hydro electric power facilities, wherein the generated power amount is controlled such that overall fuel consumption amount of the system which includes many thermal power facilities is lower than the predetermined value and energy is transmitted from the system which includes many hydro electric power facilities. Furthermore, the system comprises a system having electric power of good quality and a system having electric power of poor quality and the system is controlled such that the power flow flows from the system of good electric power to the system of poor electric power. Furthermore, the systems are located in countries having at least 2 hours time difference and the energy transmitted from one system to another system is controlled using demand estimation data of respective systems. Furthermore, an alternating current/direct current converter may be provided between the system and the energy path and is information transmission means for transmitting information to control the alternating current/direct current converter, at least one of satellite communication facilities, optical communication facilities, microwave communication facilities and telephone circuit communication facilities is provided. The information communication means is provided with delay timers. Furthermore, the information includes information on the system, or information to which time information detected by a transmission time difference detector for detecting time difference for information transmission is added, or the interchanged electric energy, the restriction on the interchanged electric energy, or operation information on a direct current power transmission system. A consideration to the settlement, conclusion of contract or interchange control by the above-mentioned interchange administration equipment may be at least one of the CO₂ emission right which concerns with CO₂ emission utilities, fuel, electrical energy or money. Furthermore, the energy and power interchange system is provided with a power interchange control equipment and such a power interchange control equipment decides the operating condition of the generator, or the operating condition of the power storage equipment, or the interchanged electrical energy/between the alternating current systems using at least one of interchangeable electrical energy, the electrical energy, load of respective alternating current systems, generated energy, emergency power source. Furthermore, the interchange power command value is decided using at least one of demand information, power generating information, exchange rate information, power generating cost information and power transmission information. Furthermore, using at least one of the power cost, the power generating and transmission cost, CO₂ emission amount, load balancing index, demand and supply balance index, or power supply reliability index of respective countries or regions or of every hours or every seasons is formed as an object function, the interchanging power command value is decided based on the calculation result of a calculation processing equipment which executes an optimization calculation.

Furthermore, the energy and power interchanging method is characterized in that a first system which is provided with power generating facilities and a second system in a foreign country which is provided with power generating facilities are interconnected by an energy path constituted by a direct current power transmission system and the transmitting energy is measured by a measuring equipment mounted on the energy path and the control parameters of the first system or the second system are changed or the energy transmitting direction is decided in response to the energy amount measured by the measuring equipment.

Furthermore, converted values of the cost including the energy generating cost and the energy transmission cost and the converted values of the environmental load including generated carbon oxide gas are obtained based on information measured by the measuring equipment and the settlement, the conclusion of contract or the interchange control is carried out using the converted values.

### BRIEF DESCRIPTION OF THE DRAWINGS

FIG. 1 is a view showing Asia Pacific Rim Electricity Cooperation (APREC) according to one embodiment of the present invention.

FIG. 2 is a perspective view showing an example of installing a pipe line and a power transmission line using the same route.

FIG. 3 is a block diagram showing the interconnections by way of measuring modules.

FIG. 4 is a block diagram showing the interconnections to which CO₂ measuring modules are applied.

FIG. 5 is a flow chart showing one example of method for carrying out the settlement of transaction of energy between systems

FIG. 6 is a block diagram showing one example of method for carrying out the transaction of energy between systems.

FIG. 7 is a graph showing the change of electricity consumption of one day in summer season.

FIG. 8 is a graph showing the change of electricity consumption in respective months.

FIG. 9 is a block diagram showing one embodiment which interconnects a plurality of alternating current systems by means of direct current power transmission systems.

FIG. 10 is a block diagram showing control of interconnection lines and information transmitting means.

FIG. 11 is a block diagram showing a plurality of systems which are interconnected by direct power transmission systems.

FIG. 12 is a block diagram which shows a plurality of alternating current systems which are interconnected by direct current power transmission systems.

FIG. 13 is a flow chart showing the manner for maintaining the power supply reliability in the systems shown in FIG. 12.

FIG. 14 is a flow chart showing the method which purchases electricity from other systems.

FIG. 15 is a block diagram showing the interchanged power control by the direct current of direct current interconnection with a remote site.

FIG. 16 is a block diagram which measures the delay of transmission path shown in FIG. 15.

### DETAILED DESCRIPTION OF THE PREFERRED EMBODIMENTS

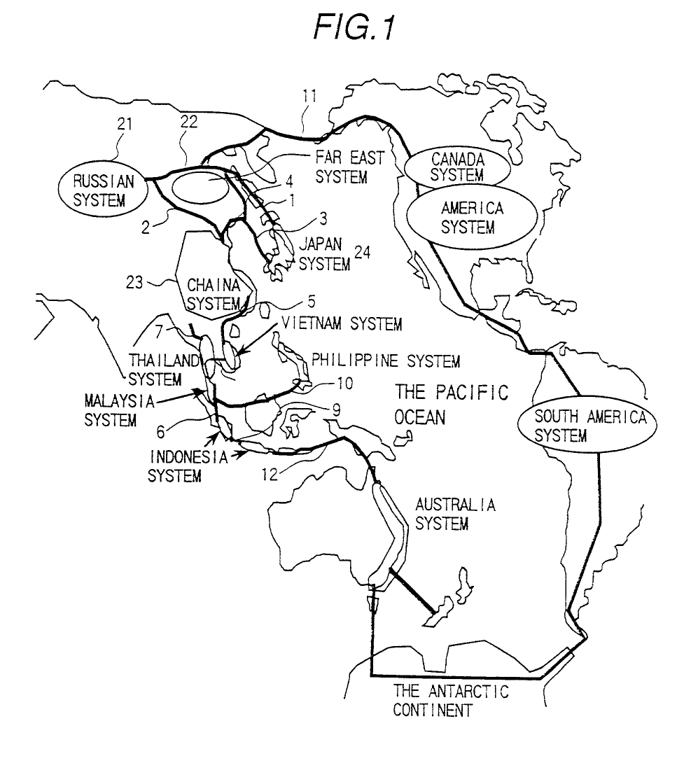

The one embodiment of the present invention is explained in conjunction with FIG. 1 to FIG. 16.

FIG. 1 shows systems in countries around Asia and Pacific rim and interconnection lines of an energy and power interchange system which connect a plurality of countries in the region. Main systems are the Canada system, the America system, the Russia system, the Far East system, the Japan system, the China system, the Vietnam system, the Thailand system, the Malaysia system, the Indonesia system, the Australia system and the South Pole system.

In FIG. 1, as shown in a solid line, the interconnection line 1 interconnects Russia and Hokkaido of Japan to transmit power therebetween. The interconnection line 2 interconnects Russia and China to transmit power therebetween. China's electrical energy facilities capacity at the end of 1996 is 236 GW which is larger than 227 GW of Japan. Namely, China is the second in the world in terms of electrical energy facilities capacity and it consists of 76% of thermal power, 23% of hydro electric power and 1% of nuclear power. In the ninth five year program started from 1996, it is planned that electrical energy facilities will be increased by 17 GW at average every year until 2000 and the system of power transmission and distribution will be strengthened. As envisaged from the project of Sanxia hydro electric energy facilities, although China is positively advancing its development, there still remains a possibility that China will suffer from the shortage of electric power for her electric power demand.

The interconnection line 3 interconnects South Korea and Japan to transmit power therebetween. The interconnection line 4 interconnects South Korea and China to transmit power therebetween. The interconnection line 5 interconnects the Vietnam and China to transmit power therebetween. The interconnection lines 6, 7, 8 respectively interconnect Malaysia, Myanmar, Laos and Thailand to transmit power to respective countries.

The interconnection line 9 interconnects Sumatra and Java to transmit power therebetween. The interconnection line 10 interconnects Malaysia and Philippine to transmit power therebetween. The interconnection line 11 interconnects Canada and Russia to transmit power therebetween. The interconnecting 12 interconnects Australia and Indonesia to transmit power therebetween. Since Australia is the vast continent, there is a sufficient space which can be developed as sites for generating power facilities so that there is a great possibility that Australia will be chosen as the site for an electric sources made of non-fossil fuel. Besides these interconnections, interconnections between following countries are considered, e.g. Laos and China, Myanmar and China, Cambodia and Thailand, Cambodia and Vietnam, Malaysia and Indonesia, Myanmar and India, Myanmar and Bangladesh, India and China, Canada and Russia, Australia and New Zealand, America and Mexico, Mexico and Caribbean countries, Caribbean countries and South American countries, South America and Antarctic Continent, Antarctic Continent and Australia and Antarctic Continent and New Zealand.

The distance of respective interconnection lines is some hundreds km—some thousands km and their power transmission capacity is some GW—some tens GW thus enabling the power interchange in a wide area.

The respective alternating current power systems which are constructed in the above manner are interconnected by the direct current power transmission systems. For example, Australia system and Indonesia system are interconnected with the interconnection 12 which is a direct current power transmission route. Japan's 50 Hz system is interconnected with Far East system and Russia system by way of Hokkaido and Sakhalin with the interconnection 1 which is a direct current power transmission system. Japan's 60 Hz system is interconnected with China system and Far East system with a direct current power transmission system. Furthermore, Canada system is connected with Far East system and Russia system by way of Alaska and the Bering Strait with the interconnection 11 which is a direct current power transmission system. In this manner, the alternating systems in respective regions of the Asia Pacific rim shown in FIG. 1 are interconnected with each other with the direct current power transmission systems. Such an interconnection with the direct current power transmission systems enables the efficient power transmission over a long distance.

A power transmission line of each direct current power transmission system is made or either a cable or an overhead line. At a portion where the alternating current system of each region is connected with the direct current power transmission system, an alternating current/direct current converter is installed. The direct current power transmission system adopts either 1:1 interconnection which makes two alternating current systems connected with a pair of alternating current/direct current converter by a direct current line or direct current multiple terminals in which alternating current/direct current converters are respectively installed in more than two alternating current systems and these are connected with each other by branched direct current lines.

In installing the direct current power transmission lines using the cable, they are installed on the bottom of the sea, or installed underground, or installed on the surface of the ground. Furthermore, if the regions are already connected with each other by pipe lines such as gas pipelines or the installation of the pipelines is planned, the direct current power transmission lines are installed on the same route as these pipelines. In this case, the direct current power transmission lines share supporting structures with the pipelines or the direct current power transmission cables can be fixedly secured to the pipe lines. Furthermore, the cable may be installed within the pipeline.

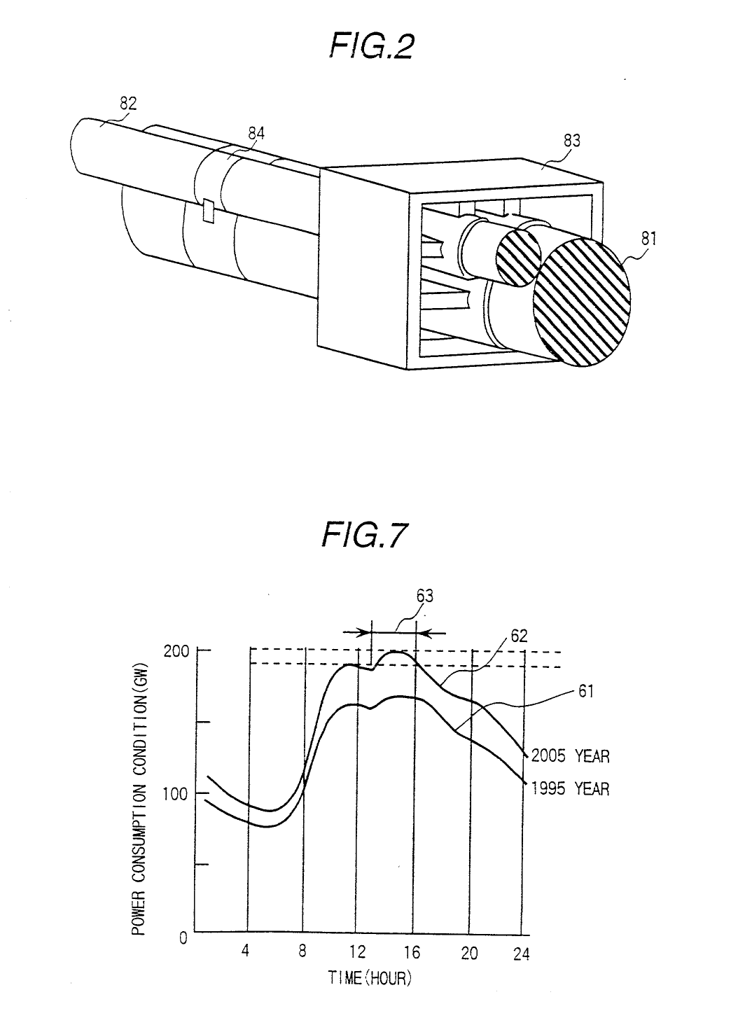

In FIG. 2, a case that a pipeline 81 and a power transmission cable 82 are installed on the same route is exemplified. Inside a supporting structure 83, the pipeline 81 and the power transmission cable 82 are installed and they are fixedly secured to the ground by means of the supporting structure 83. The power transmission cable 82 is fixedly secured to the pipeline 81 by means of a support 84. In this manner, the power transmission cable 82 shares the route and the supporting with the pipeline 81 so that the reduction of installation cost, the reduction of supporting structure cost and the reduction of monitoring equipment cost can be achieved thus enabling the reduction of construction cost.

Although the gas pipelines are considered here, similar installation methods are applicable if other distribution facilities such as petroleum pipelines are available. Furthermore, although the cables are explained considering that it is used for the direct current transmission, alternating current cables are applicable if the alternating current interconnection is used. A gas insulation line (abbreviated as GIL) which installs a conductive body in a pipe and apply a gas insulation is also applicable. Here, as the power generating facilities, any facilities which generate electric power using coal, natural gas, uranium, solar beams, and wastes can be employed.

In this manner, since the electric power systems of respective regions have their regionality and characteristics, it is rational to construct the systems in respective regions depending on respective regions and interconnections are carried out by connecting regional system of respective regions by transmission facilities. Accordingly, since interconnections includes interconnection between different systems or interconnection between systems which are remote from each other in terms of distance, the systems are interconnected by direct current interconnection facilities. Furthermore, in a case that there is no substantial difference in electric characteristics and the distance between the systems is short, the systems may be interconnected by alternating current power transmission facilities.

In countries which are arranged along the coast of the Pacific Ocean, as shown in FIG. 1, different languages are used. At present, English, French, Spanish, Portuguese, Russian, Chinese, Malay, Japanese and the like are used. Furthermore, since they differ in circulating currency, as a settlement method of energy and power interchange, the standardization of energy conversion as the standardized currency or equivalent unit, e.g. the institution to adopt APREC unit must be newly introduced. However until the introduction of such an institution, energy and power are purchased based on the fluctuation of the international exchange rate of the currencies of respective countries. To enable the electric power interchange in a wide area, it becomes necessary to exchange information on the interchange of electric energy in advance based on the electric power estimation data in the region. To this end, the language structure for communication must be standardized or translators must be used to provide a stable electric power interchange system.

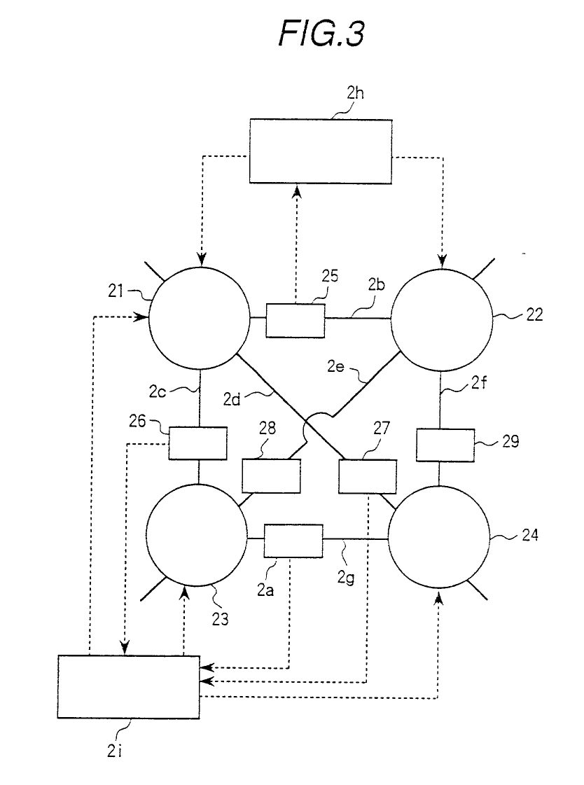

In FIG. 3, an example where Russia system 21 shown in FIG. 1, Far East system 22, China system 23, Japan system 24 are interconnected by energy paths 2b, 2c, 2d, 2e, 2f, 2g is exemplified. Measuring equipment 25, 26, 27, 28, 29, 2a are mounted on respective energy paths 2b, 2c, 2d, 2e, 2f, 2g for measuring transmitting energy amount. With such measuring equipment, the energy which moves through the respective energy path is measured. As such energy paths, at least one of the alternating current interconnection systems or the direct current interconnection systems which carry out the interconnection electrically, gas or petroleum pipelines, transport paths which transport energy sources such as petroleum, gas, uranium and the like using a transport equipment such as ships, railroads, cars, airplanes and the like, or paths or wave which propagates in air such as microwave power transmission can be applied.

In response to transmission amount of energy of respective systems which are detected by the measuring equipment 25, 26, 27, 28, 29, 2a, the parameters such as the generating power amount of respective systems or the control amount of direct current converters are changed. Furthermore, in response to the transmitting amount of energy, items having values such as information or goods are transacted between systems, or contracts are concluded or changed. Furthermore, depending on the transmitting amount of energy of respective systems, the construction of respective systems is changed.

For example, the information on energy amount from the measuring equipment 26, 27, 2a is transmitted to an interconnection adjustment equipment 2i and based on the information, the interconnection adjustment equipment 2i inform the systems 21, 23, 24 which are relevant with the transmission of energy of the information on energy or items having values equivalent to the transmission of energy, for example electric rates, other alternative energy or information on rights such as CO₂ emission rights. Based on these information, respective systems transact price corresponding to the transmission amount of energy.

Such a transaction is carried out between two systems. For example, when the electric power is transmitted from the system 21 to the system 22 by way of the direct current power transmission system, the measuring equipment 25 measures the interchanged electric energy and transmits its information to an interconnection adjustment equipment 2h. The interconnection adjustment equipment 2h transmits information on the electric energy moved to the systems 21, 22 which are relevant with the movement of the electric energy or transmits other energy amount corresponding to the electric energy or right amount such as the CO₂ emission right. In accordance with the information, the system 22 pays reward to the system 21 for the accepted electric energy.

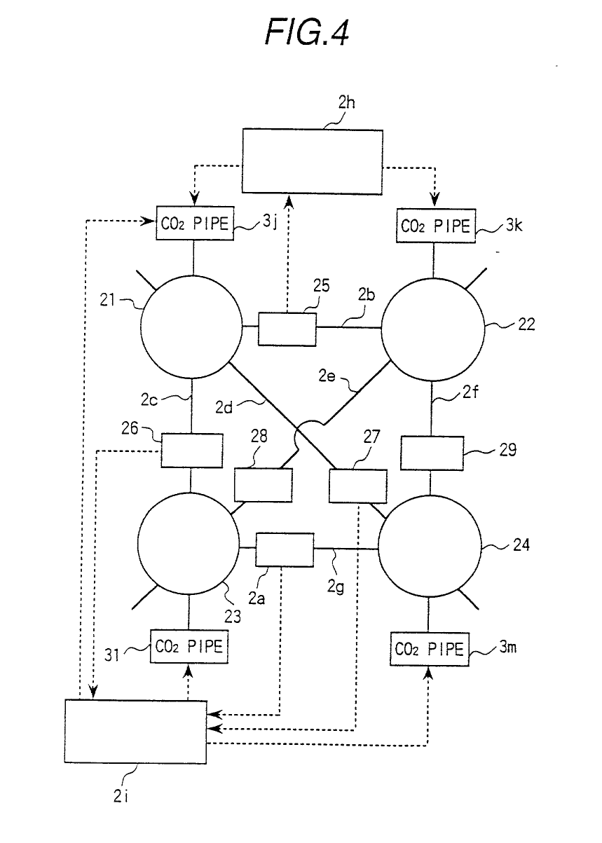

Although the system shown in FIG. 4 is constructed in the same manner as that of FIG. 3, in the system shown in FIG. 4, CO₂ administration equipment 3j, 3k, 3l, 3m which measure and administrate the CO₂ discharge amount produced by generation of power at respective systems are installed in respective systems. The interconnection adjustment equipment 2h, 2i receive the information on the energy amount transacted between systems from the measuring equipment 25, 26, 27, 28, 29, 2a and transmit CO₂ emission amount for generating energy moved in response to the information or considered to be generated for transmitting the energy to systems which are concerned with the transmitting and receiving of the energy.

For example, when the electric power is supplied from the system 21 to the system 22 by way of the direct current power transmission system, CO₂ is emitted in air from a power plant in the system 21 for generating electric power, the emitted CO₂ amount is grasped by an administration equipment 3j. Namely, at the administration equipment, the CO₂ amount generated in the system 21 is counted and then is integrated. Furthermore, the information on the electric energy from the system 21 to system 22 which is measured by the measuring equipment 25 is sent to the interconnection adjustment equipment 2h and the interconnection adjustment equipment 2h is operated such that the count value of CO₂ emission amount which corresponds to the electric energy transmitted from the system 21 to the system 22 is transmitted from the CO₂ administration equipment 3j to a CO₂ administration equipment 3k. As a result, with respect to the count value of the CO₂ administration equipment 3j, the value from which the CO₂ amount for generating the electric energy amount transmitted to the system 22 is subtracted becomes the integrated value, while in the CO₂ administration equipment 3k, the value to which the CO₂ amount for generating the electric energy amount received from the system 21 is added becomes the integrated value. In this manner, in this example, the responsibility for the generation of CO₂ is taken by the energy receiving side system and its information is grasped by the interconnection adjustment equipment 2h and the CO₂ administration equipment 3j, 3k.

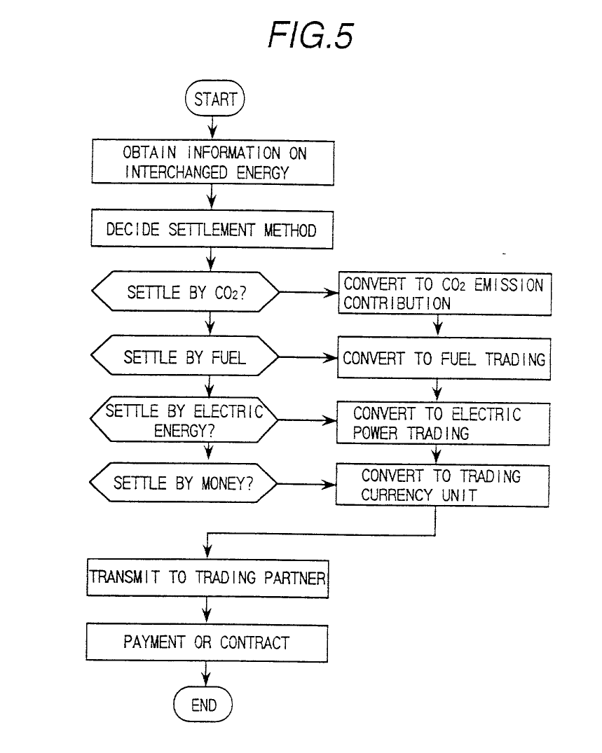

FIG. 5 is a flow chart showing an example of the method for carrying out the settlement when the transaction of energy takes place between systems, for example, shown in FIG. 3 or FIG. 4. First, the energy amount interchanged between the systems is taken in as information, and the settlement is made how to carry out the reward for the interchanged energy amount in accordance with a preliminarily decided method.

For example, when the reward for this interchanged energy is carried out by the CO₂ emission right, the interchanged energy amount is converted to the CO₂ emission burden amount. When the settlement is made by the fuel, the interchanged energy amount is converted to the fuel such as petroleum or gas. When the settlement is made by the electricity energy, the interchanged energy amount is converted to electric energy. When the settlement is made by money, the interchanged energy is converted to the preliminarily decided currency unit. When the settlement is made by money, conversion is made using the information on real time exchange rate or preliminarily decided exchange rate. The conversion result obtained in the above manner is transmitted to the system which interchanged the energy and delivers right or energy such as petroleum or gas or carries out the conclusion of a contract in accordance with the method of settlement. When the difference exists in terms of unit price of electricity energy including the power transmission loss, the interchange which corresponds to the difference of unit price is carried out so as to make both the buyer and purchaser have the economic merit. As a concrete method for this end, under a total operator as an arbitrator, the buyer and the purchaser carry out the interchange in a free market style.

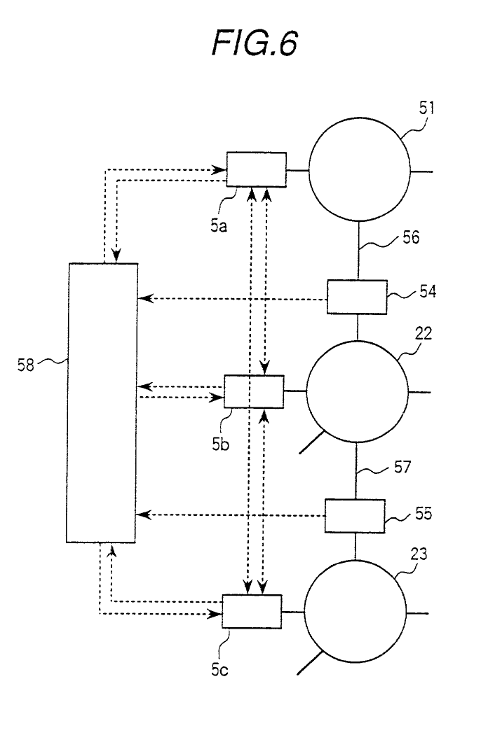

In FIG. 6, a case in which, for example, Canada system 51, Far East system 22, China system 23 are interconnected by power transmission systems is exemplified. The systems are respectively interconnected by energy paths 56, 57 and measuring equipment 54, 55 are mounted on these energy paths for measuring the energy amount which is moved between the alternating current systems. The systems are respectively provided with interchange administration equipment 5a, 5b, 5c for carrying out the transaction of electric energy with other systems and the settlement related with such a transaction. An interconnection adjustment equipment 58 which has a function of adjusting the electric power interchanged amount between systems is installed.

The manner of interchanging the electric power from the system 51 to the system 23 is explained. In this case, the power interchange can be carried out in two kinds of methods.

The first method is a method which directly concludes a contract on the interchange between the system 51 and the system 23. In this case, the interchanged electric power passes through the system 22 so that it becomes necessary to pay the system use fee of the system 22 or to ask for the system control. Accordingly, between the system 51 and the system 23, an agreement is made on the price of electric power to be interchanged, the start time of power transmission, the period of power transmission, the electric power value of power transmission, the transmitting electric energy, the quality of transmitting electric power and the like and these information is transmitted to the interconnection adjustment equipment 58. In response to the transmitted information, the interconnection adjustment equipment 58 outputs a control command to interconnection administration equipment 5a, 5b, 5c respective alternating current systems so as to carry out the interchange. In response to the control command, alternating current systems change parameters of respective systems and control the power flow of respective interconnections. The interconnection adjustment equipment 58 receives the information on the measured value of interchanged electric power from the measuring equipment 54, 55 and transmits the information on the settlement to the interchange administration equipment 5a, 5b, 5c of respective alternating current systems. In response to the transmitted information, the interchange administration equipment of respective systems carry out the settlement on the interchange such as the electric rates or the system use fee respectively.

The second method is la method in which the interchange contract is concluded between neighboring systems respectively. For example, the system 23 concludes a contract to receive the necessary power interchange from the neighboring system 22 and the system 22 concludes a contract to receive the necessary power interchange from the neighboring system 51 so that the power interchange from the system 51 to the system 23 becomes possible. In this case, the contract may be concluded between the system 51 and the system 22 and between the system 22 and the system 23. This method corresponds to a case of the first method in which no other system is interposed in the interchange path. In this second method, the interchange control and the settlement can be carried out in the same steps as those of the first method.

In the example shown in FIG. 6, making use of the hydro power of Canada, the generation amount of CO₂ by the thermal power generation of the same capacity in China can be reduced so that it can contribute to the prevention of warming of the earth. Furthermore, there is approximately eight hours time difference between Canada and China, lowering of system peak load can be realized making use of the difference of power transmission time.

FIG. 7 shows the change of electricity consumption condition of one day in summer season. The example shown in FIG. 7 is the electric power system in Japan and a curve 61 indicates the change of electricity consumption in 1995. The electricity consumption increases rapidly from approximately 6 o'clock when people usually get up. Although the electricity consumption drops temporarily at 12 o'clock or at lunch break, it again increases with the use of air conditioners for cooling from 13 o'clock and reaches approximately 170 GW around 15 o'clock and thereafter sharply drops. The electricity energy demand is increasing year by year and it is estimated that the system peak load will reach 200 GW as shown with a curve 62. As a measure to cope with this situation, for example, at the time of system peak load during three hours in the afternoon as shown with a symbol 63, if the electric power system of Japan receives the power interchange from the system which has the time difference, the system peak load of Japan can be reduced by approximately 10 GW. Furthermore, to reduce the system peak load of Japan by approximately five GW, the time difference of approximately 2 hours is sufficient so that, for example, the time difference of 2 hours between Bangkok and Japan can be made use of.

In this manner, by interchanging the electric power with less transmission loss because of the short transmission distance from close regions of at least 1-2 hours time difference at the time of system peak load, the system peak load during 1-2 hours when the electric energy demand becomes high can be reduced.

Furthermore, there is 6 hours time difference between Japan and Anchorage so that the power interchange can be carried out sufficiently. Still furthermore, At 15 o'clock which shows the system peak load in Japan, Vancouver of Canada, Los Angels and San Francisco of America are at 22 o'clock at night so that the power change between daytime and nighttime is effectively made use of. When New York of the eastern coast of America is 1 o'clock at midnight, an excess amount of its electric power at night can be effectively interchanged to Far East system, China system, Japan system, Philippines system, Vietnam system, Thailand system, Malaysia system, Indonesia system, and Australia system of Asian region.

In this manner, although the transmission loss is great, the power transmission from the relatively remote place which reverses the daytime and nighttime can interchange the midnight cheap electric power for a relatively long time so that the daily load factor can be improved and pumped power loss can be reduced.

In the actual operation, using the estimated data on electric energy demand of at least two points which differ in the system peak load at daytime, the interconnecting operation between electric power systems including these points is carried out such that the excess electric power which exceeds given electric power at either one point is transmitted to the other point.

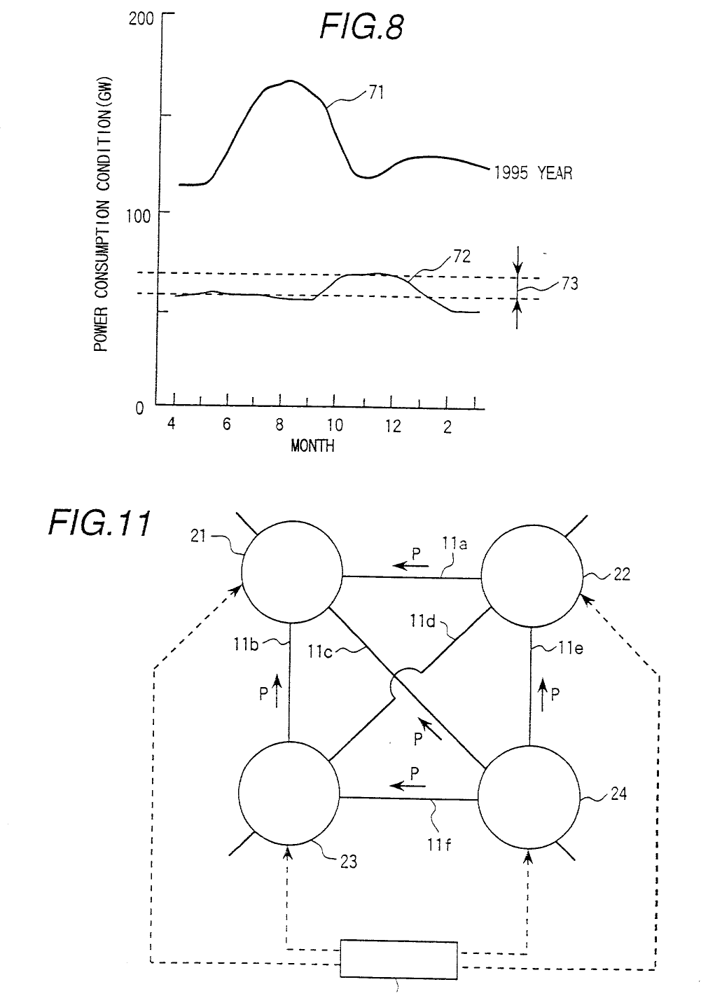

FIG. 8 is a view showing the change of monthly electricity consumption condition of electricity. As shown in FIG. 8, a curve 71 shows the transition of electricity consumption of Japan in 1995. Although the electricity consumption reaches the system peak load of approximately 170 GW in August in summer season, the electricity consumption considerably drops in winter season since October. Accordingly, to the electric power system which has its system peak load after October as shown in a curve 72, approximately 10 GW of electric power can be interchanged as an excess electric power as depicted by a symbol 73. For example, since there is a difference in season between the northern hemisphere and the southern hemisphere, the power interchange can be carried out making use of this difference of season.

In this manner, between the southern and northern regions which differ in season such as summer and winter, the power interchange of a long period can be carried out with each season as a unit so that the annual load factor can be improved and the base power sources amount can be more economical.

In the actual operation, using the estimated data on electric energy demand of at least two points which differ in the system peak load in season, the interconnecting operation between electric power systems including these points is carried out such that the excess electric power which exceeds given electric power at either one point is transmitted to the other point

Furthermore, as an environment of the power generating plants, there are systems which include many thermal power plants and systems which include many hydro electric power plants. By interconnecting the system which includes many thermal power plants and the system which includes many hydro electric power plants, wherein the system which includes many thermal plants is a coal thermal power plant, the power generating facilities in respective electric power systems can be operated such that the total fuel consumption in a predetermined period becomes below a predetermined value to restrict the generation of CO₂ for example. In this case, when the shortage of electric power is expected, an output increases command of the hydro electric power generation of the interconnected system can be requested in advance. With such a control, the generation amount of CO₂ caused by the thermal power generation can be reduced thus contributing to the prevention of warming of the earth.

Furthermore, electric power sources such as undeveloped hydro power in areas which electric energy demand is small or nuclear power which generate the least amount of earth warming gas such as undeveloped hydro power in areas which electric energy demand is small or nuclear power may preferably developed and they may be interchanged through the interconnection lines so as to use them as electric power sources which substitutes the thermal power in areas where the electric energy demand is high thus reducing the environmental load.

Furthermore, the two-way utilization of the electric power is also considered. As explained previously with respect to the power interchange making use of the time difference and the power interchange making use of the difference of season, respective generated powers are fully made use of and through the power interchange between different countries, the working rate of the facilities is increased so that cheap electric power becomes available. There are fluctuating factors with respect to the electric energy supply ability and the electricity unit price because of the abundant water or drought of hydraulic power sources, the fluctuation of fuel unit price of thermal power sources, the periodical checking of the nuclear power sources or the long-term stop caused by troubles. The instability of electric power supply can be eliminated by connecting the areas which differ in the electricity source composition such that the thermal power is interchanged during the period of drought and the hydro electric power is interchanged at the time of stop of the nuclear power. As concrete methods for assuring the stability of electric power supply, with respect to a long-term plan, the electric power is supplied and received in an annual or monthly plan, while with respect to a condition related with a trouble on electric power sources, information are gathered at a place where an overall operation is carried out and an on-line judgement is made there.

It may be possible to interconnect the power generating area and the power consumption area to carry out the stable electricity energy supply. For example, as already explained with respect to the interconnection line 2 in FIG. 1, by transmitting the electric power generated by hydraulic power and thermal power in Russia to the China system where a sharp increase of electricity demand is expected from now on, Russia can obtain foreign currency while China can stabilize its electricity energy supply.

When an accident occurs in the power system, the electric power is urgently supplied from the area having no trouble so as to prevent a large-scale power failure or a long time power failure. Due to such a measure, the reliability of power supply is enhanced and a reserve electric energy supply which becomes necessary at the time of occurrence of accident can be minimized thus providing an economic effect. As concrete measures, the systems are connected by direct current interconnecting equipment such that the occurrence of the accident is automatically detected upon drastic lowering of the frequency of the system and for automatically flowing the electric power to the interconnection line in response to the degree of the accident, information on the condition of the accident and the condition of the system before the occurrence of the accident are gathered at a place where an overall operation is carried out and an overall judgement is made by an automatic control equipment thus facilitating the control of the power flow. In this case, autonomous distributed control is carried out. When the drought occurs because of El Nino phenomenon and the normal hydro electric power amount is drastically reduced, the system can receive the power interchange from countries and regions which have sufficient electric power sources.

Since the system of this embodiment interconnects the systems of regions which largely differ in electric characteristics and are geographically located randomly and they also differ in their needs for the operation of systems, their interests may conflict. To make this system perform its expected effects or advantages, an overall operation control center is necessary, wherein the center is an organization which observes the system as a whole and totally operates and controls the system. This overall operation control center gathers information necessary for the operation of the system such as the power flow conditions of respective power interconnecting facilities, information necessary for knowing the excess transmission power of interchanged power flow in respective systems, the unit price of interchanged power in respective regions, the transmission loss fee corresponding to the interchange distance, the excess generated power in respective regions, request for receiving of electric power and its degree of urgency, the presence of the accident in the systems and carry out the effective operation with the aid of an automatic operation support system.

Furthermore, the utilization of power interchange to countries which differ in the quality of the electric power is considered. To the region of low electric power quality where the fluctuation of frequency is large even during the normal operation time, for example, the power flow which can improve the fluctuation of the frequency is flown thus improving the characteristics of the system. Accordingly, the construction of an advanced cutting-edge industry becomes possible so that the economy is activated.

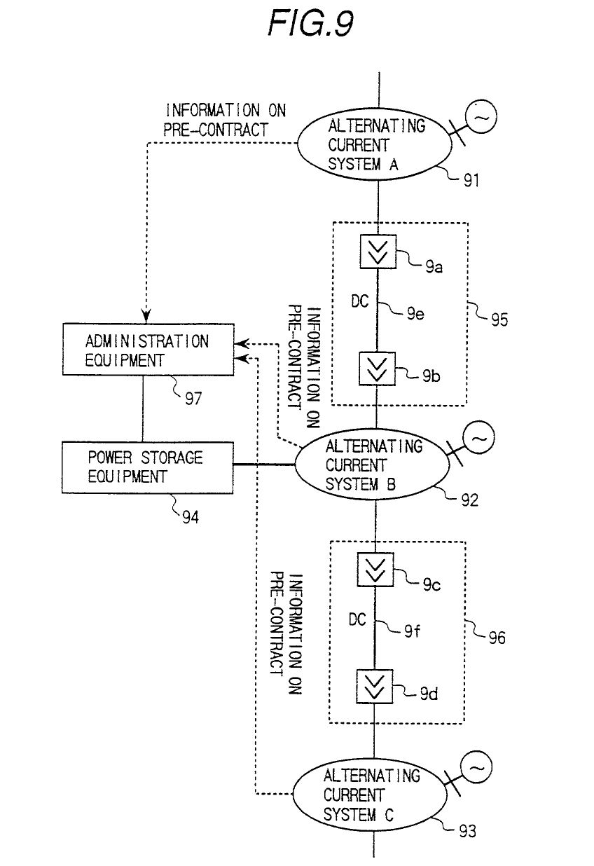

FIG. 9 shows one embodiment which interconnects a plurality of systems with direct current power transmission systems. Alternating current systems 91, 92 are interconnected by a direct current power transmission system 95 which is provided with an alternating current/direct current converters 9a, 9b and a direct current power transmission line 9e. Alternating current systems 92, 93 are interconnected by a direct current power transmission system 96 which is provided with an alternating current/direct current converters 9c, 9d and a direct current power transmission line 9f.

A power storage equipment 94 is mounted on the alternating current system 92. In this manner, with the power storage equipment 94 mounted on the alternating current system 92, for example, when any system trouble occurs in the alternating current system 91 or when the interconnection power flow from the alternating current system 91 to the alternating current system 92 is suddenly changed due to the malfunction of the direct current power transmission system 95, the output of the power storage equipment 94 is changed in response to the change amount so that stability of the alternating current system 92 is maintained and the fluctuation of the frequency can be restricted. As the power storage equipment, a secondary battery, SMES, a flywheel, a pumped storage power generating system and the like are applicable. Furthermore, although the power storage equipment consists of a type of equipment which directly stores the electric energy and a type of equipment which converts the electric energy in energy of other form and stores the converted energy, either equipment is applicable so long as electric energy can be inputted or outputted speedily in response to a command.

In a case that the alternating current system 93 and the alternating current system 92 belong to different countries or different management bodies, although the location where the power storage equipment 94 is installed is the alternating current system 92, an administration equipment 97 for administrating the power storage equipment 94 is provided, wherein the administration equipment 97 preliminarily administers the property of energy stored in the power storage equipment 94, the license to use the converter of the power storage equipment 92 and the like. The administration equipment 97 is set such that the alternating current system 93 preliminarily gives information on the acquisition of the right to the administration equipment 97 so that the administration equipment 97 can acquire the right preliminarily. Due to such a setting, at the time of emergency such as the shortage of electric energy supply to the alternating current system 92 caused by the sudden stop of the direct current power transmission system 95, the alternating current system 93 can preferentially receive the electric energy supply from the power storage equipment 94 by way of the direct current power transmission system 96. In this case, although it becomes necessary to maintain the stability of the alternating current system by taking measure such as interruption of the load to cope with the shortage of electricity power supply, the administration equipment 97 is set such that it owes the responsibility to transmit the electric power of the power storage equipment 94 to the alternating current system 92 in accordance with the contract which is concluded in advance.

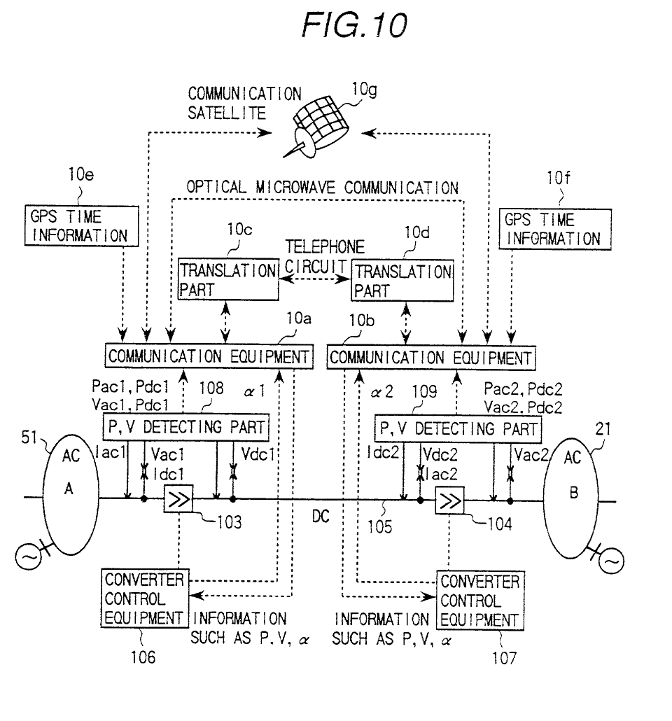

FIG. 10 is a view showing an example of the construction of the interconnection which connects Canada system 51 and Russia system 21 shown in FIG. 1. These alternating current systems 51, 21 are respectively provided with alternating current/direct current converters 103, 104 and the alternating current/direct current converters 103, 104 are interconnected by a direct current power transmission line 105. The alternating current/direct current converters 103, 104 are respectively controlled by converter control equipment 106, 107. The voltage and current values of the alternating current side and the direct current side of the converter 103 of the alternating current system 51 are converted to signals such as an alternating current electric power detected value Pac1, an alternating current voltage value Vac1, a direct current electric power detected value Pdc1, a direct current voltage value Vdc1 and the like at a P, V detecting part 108. Information including these values and a trigger angle command value α 1 transmitted from the converter control equipment 106 is transmitted to the converter control equipment 107 at the opposite end by way of communication equipment 10a, 10b. The transaction of information between the communication equipment 10a, 10b is carried out by the satellite communication by way of a communication satellite 10g, an optical communication by way of optical cables, a microwave communication or a telephone circuit.

Furthermore, the alternating current systems 101, 102 are respectively provided with GPS time information acquisition equipment 10e, 10f which can obtain time information from GPS (abbreviation of Global Positioning System which is a wide area position measuring system). The GPS time information acquisition equipment 10e, 10f prepare data by adding the time information obtained from the GPS to the information such as alternating current power detected value at respective time cross sections. By transmitting data to which this time information is added, the converter control equipment 106, 107 at the opposite end and the like can grasp the time delay incurred by transmission and can carry out the control while synchronizing. Furthermore, when the telephone circuit is used, not only information can be transmitted in a digital data mode by way of a modem but also information may be transacted such that operators of respective converters converse in voice by way of telephones. When the languages used become different because of the difference in countries where the converters 106, 107 are installed, language translation parts 10c, 10d may be provided between the communication equipment 10a, 10b. Although generally the language translation parts 10c, 10d may be constructed by translation machines, men can carry out the translation work. In this manner, in the direct current interconnection of a long distance which extends between the Asia and American Continents, with the provision of a plural information transmission methods considering the time lag, not only the highly reliable power interchange becomes possible but also the selection of the inexpensive information transmission method becomes possible.

FIG. 11 shows an example where Russia system 21, Far East system 22, Japan system 24 and China system 23 are respectively interconnected by direct current power transmission systems 11a, 11b, 11c, 11d, 11e and 11, for example. When the direct current system 11c is stopped for example, the direct current power transmission systems are respectively controlled such that the respective interchanged power of the direct current power transmission systems 11a, 11b, 11e and 11f are increased so as not to change the power interchanged from the system 24 to the system 21. Furthermore, a direct current interchanged power decision equipment 115 and communication facilities are provided for giving a command to the alternating current/direct current converters of the direct current power transmission systems to carry out the control. Furthermore, information such as information that the direct current power transmission system 11c is stopped, the electric energy interchanged to respective direct current transmission systems, restrictions on the interchanged power and the like is transmitted to the direct current interchanged power decision equipment 115 and the direct current interchanged power decision equipment 115 controls the direct current interchanged power considering these values.

For example, when the direct current power transmission line of the direct current power transmission system which connects Malaysia system and Philippine system shown in FIG. 1 is installed on the bottom of the sea by way of a cable, a route may be chosen so as to install the direct current power transmission line less than 1000 meters below the sea level. By installing the direct current power transmission line in such a shallow sea region, the installation cost can be reduced and the maintenance of the cables is facilitated. Furthermore, a support system which displays the investigation results of such a route may be provided.

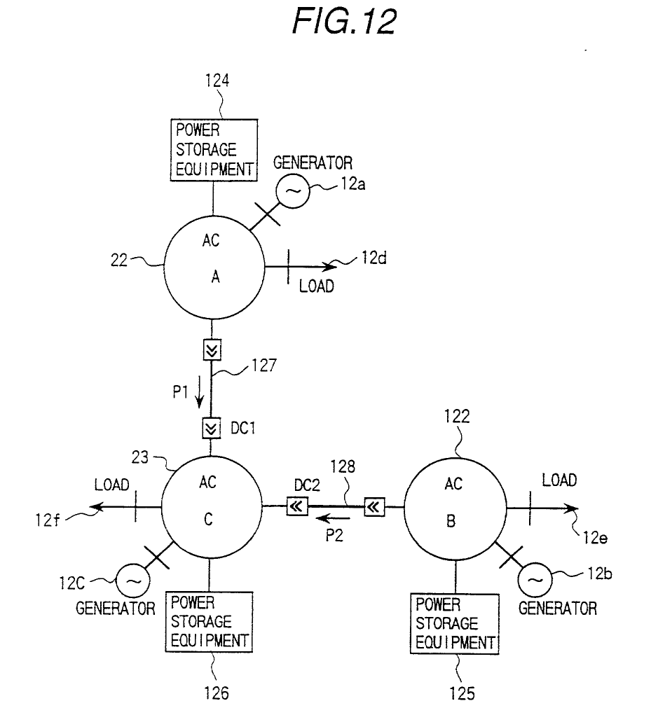

FIG. 12 is a view showing a case that a plurality of alternating current systems are connected by direct current power transmission lines such that Far East system 22, China system 23 and Vietnam system 122 are connected by interconnection lines for example. Here, the system 23 is provided with a power generating equipment 12c and a power storage equipment 126 which make the system 23 take the balance between the supply and demand of electric energy within the system 23. The system 23 is also provided with facilities which set the maximum output of the power storage equipment 126 and the maximum output of the power generating equipment 12c greater than the maximum value of the load 12f. As a result, even when the interchange from other alternating current system 22 becomes impossible due to a failure of the direct current power transmission system, the balance of supply and demand of electric energy in the alternating current system 23 can be maintained. Furthermore, for enhancing the reliability of the electricity power supply, even when the transaction of power between the alternating current system 23 and the other alternating current system 22 or the system 122 suddenly becomes impossible, the input and output and the stored amount of the power storage equipment 126 and the an excess power of the power generating equipment 12c are ensured so that the balance of supply and demand of the electric energy can be maintained within the system 23. Furthermore, when the reliability is ensured with respect to the supply of electricity from the system 22 to the system 23 by way of the direct current power transmission system 127 for example, even if the transmission and receiving of power between the system 122 and the system 23 is stopped, the input and output and the stored amount of the power storage equipment 126 and the an excess power of the power generating equipment 12c are ensured. Furthermore, at the time of emergency such as a sudden stop of the direct current power transmission systems 127, 128, instead of carrying out the transaction of electric energy between the system 22 and the system 23 for example, other energy such as gas or petroleum is transacted thus enabling the transmitting and receiving of energy which meets the preliminarily concluded contract.

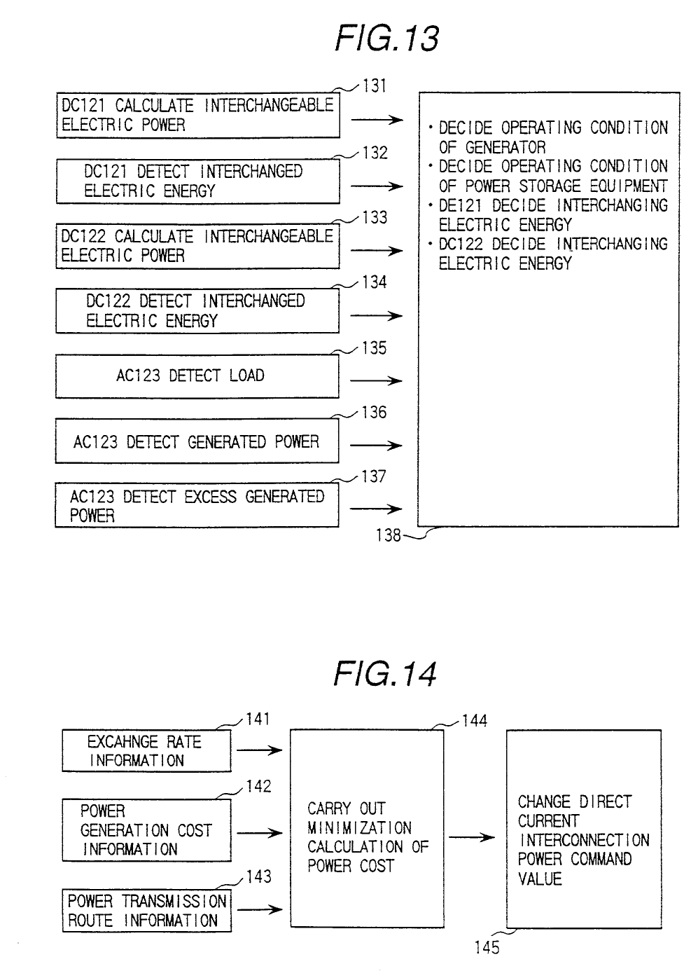

FIG. 13 is a flow chart which shows measures to maintain the reliability on the electric energy supply within the system 23 shown in FIG. 12. In accordance with steps 131, 133, the interchangeable power amount from the systems 22, 122 is calculated and the realtime interchanged power amount from the systems 22, 122 are respectively detected at steps 132, 134. Besides these steps, the load amount, time power generating amount and the excess generating power of the system 23 are detected at steps 135, 136, 137. Using these information, the operating condition of the generator, the operating condition of the power storage equipment and the interchange amount through the direct current power transmission systems 127, 128 are detected at a step 138. To be more specific, the respective command values are set such that when the direct current power transmission system 127 is stopped and the electric power interchanged from the system 22 to the system 23 is reduced, the electric power which makes up for the reduced amount of electric power is interchanged from the excess generator power, the power storage equipment and the alternating current system 122. In this example, although the interchange amount of direct current power transmission system is decided, instead of this, the same control can be carried out by changing the interchange amount contract of the alternating current system at the opposite end of the direct current power transmission system.

FIG. 14 is a flow chart which shows one example of a method in which Japan system purchases electric power from other system by way of the interconnection line. The method aims at minimizing of the cost and FIG. 14 shows the flow for deciding the most suitable electric power purchasing pattern. In this example, information 141 on exchange rate, information 142 on the power generation cost of other systems, information 143 on alternating and direct current power transmission route for transmitting purchased electric energy and the like are obtained using Internet information or direct transmission means every seconds. Based on these information, at a step 144, a formulated optimization problem is solved using the overall cost including the power generation cost and power transmission cost as an object function so that the optimum power purchasing pattern can be decided. Based on the calculated optimum power purchasing pattern, at a step 145, the interchange amount of the direct current power transmission system of the interconnection line can be calculated. In this example, although the minimizing of the cost is used as the object function, it may be possible to obtain the information on CO₂ emission amount and to decide the power purchasing pattern while including minimizing of CO₂ emission amount or the like into the object function. Besides these, balancing of the load of the Asia-Pacific rim as a whole, the degree of balance between transmitting and receiving, the reliability of the power supply may be set as the object function.

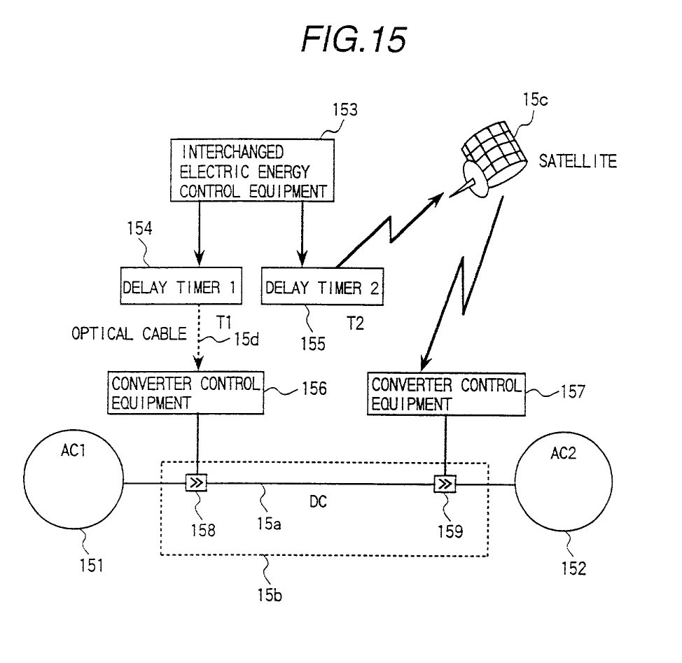

FIG. 15 is a view showing one example of the method for controlling of electric energy interchanged using the direct current when remote areas such as Canada system 51 and Russia system 21 and the like shown in FIG. 1 are interconnected by a direct current power transmission system 15b which includes converters 158, 159 and a direct current circuit 15a. An interchanged power control equipment 153 which decides the electric energy interchanged by way of the direct current power transmission system 15b gives the control command values to respective converter control equipment 156, 157. In this case, as means for transmitting information from the interchanged power control equipment 153 to respective converter control equipment 156, 157, if one information transmitting means includes an optical cable 15d while the other information transmitting means is a satellite communication by way of a satellite 15c, this gives rise to a difference in their transmission times. In this case, to make the commands reach both converter control equipment 156, 157 simultaneously, delay timers 154, 155 are respectively mounted on respective information paths.

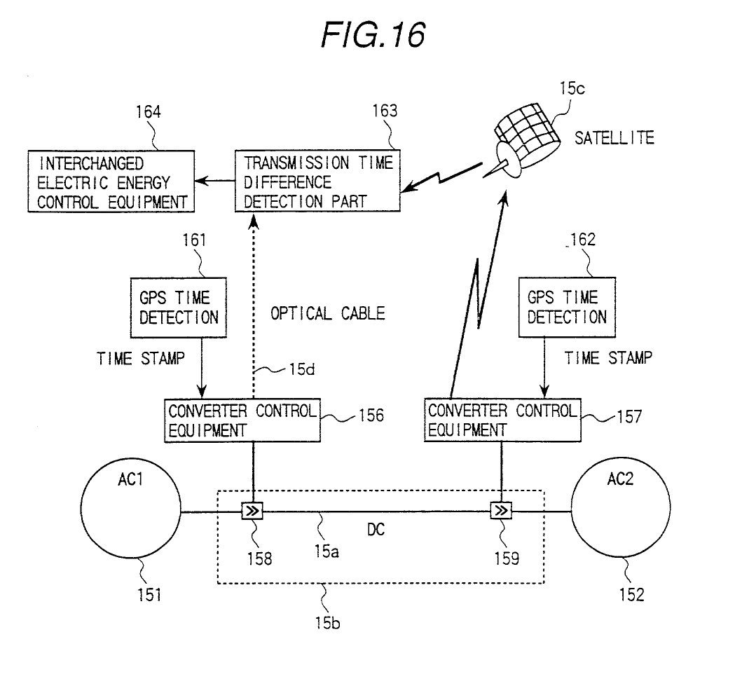

Furthermore, FIG. 16 is a view showing one example of the construction which measures the delay of the transmission paths in FIG. 15. The converter control equipment 156, 157 respectively send information which is produced by adding time information to signals having synchronism such as GPS obtained by GPS time detecting equipment 161, 162 to a transmission time detection part 163 located in the vicinity of an interchanged power control equipment 164 by way of a satellite communication transmission path which uses the optical cable 15d and the satellite 15c. Since the times necessary for transmitting information from respective converter control equipment 156, 157 to the transmission time detecting part 163 and the interchanged power control equipment 164 are the same, the transmission time detection part 163 extracts time information from information transmitted and transmission time difference of a plurality of transmission routes is detected. By passing the information on transmission time difference to the interchanged power control equipment 164, it becomes possible to decide the set values of the delay timers 154, 155 of FIG. 15.

In countries like Japan where energy sources such as petroleum, coal and natural gas is scarce, it is the reality that energy sources are daily transported on the surface from countries with enough energy sources. For example, in case of liquefied petroleum gas, in 1994, out of the total import amount, 44% is imported from Indonesia, 18% is imported from Malaysia and 15% is imported from Australia. Using the Asia-Pacific power network of this embodiment, in place of shipping, Japan can receive the energy supply constantly. The transport of the liquefied natural gas with tankers is the distributed transmission (bucket type), whereas the Asia-Pacific power network can transport continuously.

As has been explained heretofore, according to the present invention, with the provision of the power interchange in the wide area making use of the time difference and the regional difference particularly, following effects (1)-(4) can be achieved, wherein the effect (1) enables the preservation of global environment through reduction of CO₂ and saving of sources., the effect (2) ensures the balance of power supply and demand and the stable power supply, the effect (3) supports the large power demand which may be necessary in China, and the effect (4) activates the economy of APEC countries.

What is claimed is:

1. An energy and power interchange system comprising a system including energy generating means which generates transmittable energy using an energy source, an energy path which transmits energy generated by said energy generating means, a measuring equipment which is mounted on said energy path for measuring an amount of energy which is transmitted through said energy path, and a system which consumes energy supplied by way of said energy path, the improvement being characterized in that said energy sources used by said energy generating means and said generated energy amount are controlled in response to said energy amount measured by said measuring equipment.

2. An energy and power interchange system comprising a first system including power generating facilities, a second system in foreign countries having power generating facilities, an energy path constructed by a direct current transmission system which interconnects said first system and said second system, and a measuring equipment which is mounted on said energy path and measures an energy amount transmitted through said energy path, the improvement being characterized in that control parameters of said first and second systems are changed or said transmitting direction of energy is decided in response to said energy amount measured by said measuring equipment.

3. An energy and power interchange system comprising an energy path constituted by a direct current transmission system which interconnects systems of at least three different countries having power generating facilities and a measuring equipment which is mounted on said energy path and measures an energy amount transmitted through said energy path, the improvement being characterized in that control parameters of said systems of at least three countries are changed or transmitting direction of energy is decided in response to said energy amount measured by said measuring equipment.

4. An energy and power interchange system according to claim 2, wherein said energy and power interchange system includes an interconnection adjustment equipment which transmits converted values to respective systems in response to information measured by said measuring equipment, wherein said converted values are converted values of expenses including energy generating expense and energy transmission expense or converted values of environmental load including generated carbon oxide gas.

5. An energy and power interchange system according to claim 4, wherein said energy and power interchange system includes an interchange administration equipment which carries out settlement, conclusion of a contract or an interchange control using said converted values transmitted from said interconnection adjustment equipment.

6. An energy and power interchange system according to claim 2, wherein said energy path is disposed along other energy transport route and is installed such that said energy path is directly secured to said other transport route or secured to said other energy transport route while sharing a same support structure with said other transport route or said energy path is installed at a point higher than 1000 meters below the sea level.

7. An energy and power interchange system according to claim 2, wherein a power storage equipment is installed in at least one of said systems and the input and output of said power storage equipment is controlled in response to change of power flow rate between systems.

8. An energy and power interchange system according to claim 1, wherein said energy path is one selected from a group consisting of an alternating current system, a direct current interconnecting system, a pipeline, a transport path and an electric wave path.

9. An energy and power interchange system according to claim 2, wherein the above-mentioned respective systems are located at countries which differ in circulating currency and they convert to the preliminarily decided currency unit or carry out such a conversion based on information on exchange rate or said respective systems are located in countries which differ in languages and said information is transmitted by way of translating machines.

10. An energy and power interchange system according to claim 2, wherein said system comprises one system which includes many thermal power facilities and the other system which includes many hydro electric power facilities, and generated power amount is controlled such that overall fuel consumption amount of said system which includes many thermal power facilities is lower than predetermined value and energy is transmitted from said system which includes many hydro electric power facilities.

11. An energy and power interchange system according to claim 2, wherein said system comprises a system having electric power of good quality and a system having electric power of poor quality and said system is controlled such that power flow flows from said system of good electric power to said system of poor electric power.

12. An energy and power interchange system according to claim 1, wherein said systems are located in countries having at least two hours time difference and energy transmitted from said one system to said another system is controlled using demand estimation data of respective systems.

13. An energy and power interchange system according to claim 2, wherein an alternating current/direct current converter is provided between said system and said energy path and as information transmission means for transmitting information to control alternating current/direct current converter, at least one of satellite communication facilities, optical communication facilities, microwave communication facilities and telephone circuit communication facilities is provided and said information communication means is provided with delay timers.

14. An energy and power interchange system according to claim 13, wherein said information includes information on said system, or information to which time information detected by a transmission time difference detector for detecting time difference for information transmission is added, or said interchanged electric energy, restriction on said interchanged electric energy, or operation information on a direct current power transmission system.

15. An energy and power interchange system according to claim 5, wherein a consideration to said settlement, conclusion of contract or interchange control by said interchange administration equipment may be at least one of CO₂ emission right which concerns with CO₂ emission utilities, fuel, electrical energy or money.

16. An energy and power interchange system according to claim 2, wherein said energy and power interchange system is provided with a power interchange control equipment and such a power interchange control equipment decides operating condition of said generator, or operating condition of said power storage equipment, or interchanged electrical energy between said alternating current systems using at least one of interchangeable electrical energy, electrical energy, load of respective alternating current systems, generating energy, emergency power source or an interchange power command value is decided using at least one of demand information, power generating information, exchange rate information, power generating cost information and power transmission information, or using at least one of power cost, power generating and transmission cost, CO₂ emission amount, load balancing index, demand and supply balance index, or power supply and a reliability index of respective countries or regions or every hours or every seasons is formed as an object function, and an interchanging power command value is decided based on calculation result of a calculation processing equipment which executes an optimization calculation.

17. An energy and power interchange method characterized in that a first system which is provided with power generating facilities and a second system in a foreign country which is provided with power generating facilities are interconnected by an energy path constituted by a direct current power transmission system and transmitting energy is measured by a measuring equipment mounted on said energy path and control parameters of said first system or said second system are changed or energy transmitting direction is decided in response to energy amount measured by the measuring equipment.

18. An energy and power interchange method according to claim 17, wherein converted values of cost including energy generating cost and energy transmission cost and converted values of environmental load including generated carbon oxide are obtained based on information measured by said measuring equipment and settlement, conclusion of contract or interchange control is carried out using said converted values.
